(19) United States
(12) Patent Application Publication
(10) Pub. No.: US 2014/0067956 A1
(43) Pub. Date: Mar. 6, 2014

(54) INFORMATION DISPLAY DEVICE AND MOBILE TERMINAL DEVICE

(71) Applicants: Seiichi TSUNODA, Nissin-shi (JP); Daiki ISOGAI, Aichi-ken (JP); Yasutomo KATO, Toyota-shi (JP)

(72) Inventors: Seiichi TSUNODA, Nissin-shi (JP); Daiki ISOGAI, Aichi-ken (JP); Yasutomo KATO, Toyota-shi (JP)

(73) Assignee: TOYOTA JIDOSHA KABUSHIKI KAISHA, Toyota-shi (JP)

(21) Appl. No.: 14/012,531

(22) Filed: Aug. 28, 2013

(30) Foreign Application Priority Data
Sep. 6, 2012 (JP) 2012-196022

(51) Int. Cl. H04L 29/08

(52) U.S. Cl. CPC H04L 67/22
USPC 709/204

(57) ABSTRACT

An information display device includes: a position acquisition unit configured to acquire a posting relevant location associated with posted information on a posting site; and an image display unit configured to display a posting relevant image that is an image associated with the posted information on the posting site and that includes an image indicating a type of the posting site. The image display unit is configured to display the posting relevant image at a location based on a remoteness and direction of the posting relevant location with respect to a current location within a predetermined display area about a location on a display screen, corresponding to the current location.

### INCORPORATION BY REFERENCE

The disclosure of Japanese Patent Application No. 2012-196022 filed on Sep. 6, 2012 including the specification, drawings and abstract is incorporated herein by reference in its entirety.

### BACKGROUND OF THE INVENTION

1. Field of the Invention

The invention relates to an information display device and mobile terminal device that display an image associated with posted information on a posting site.

2. Description of Related Art

There is known an existing information display system that establishes cooperation between a mobile terminal device and an in-vehicle device and that displays posted information, received through the mobile terminal device, on a display of the in-vehicle device (see Japanese Patent Application Publication No. 2011-247831 (JP 2011-247831 A)).

The information display system classifies pieces of posted information on a specific one posting site in categories, and determines the color of a balloon corresponding to each piece of posted information by consulting a correspondence table that associates a category with the color of an icon (balloon). After that, the information display system displays each balloon color-coded in categories at a location on a map image, corresponding to positional information included in a corresponding one of the pieces of posted information. Thus, it is possible to make it easy for a driver to understand the contents of posted information without displaying the details of the posted information.

However, the above-described information display system just displays various color balloons, indicating the contents of pieces of posted information on a specific one posting site, on a map image, and does not assume the case where pieces of posted information on a plurality of posting sites are collectively managed. Therefore, the above-described information display system is not able to allow a driver to understand which posting site each piece of posted information is posted on, so brief contents of each piece of posted information are not provided for a driver in a sufficiently understandable way.

### SUMMARY OF THE INVENTION

The invention provides an information display device and mobile terminal device that are able to provide the contents of pieces of posted information in a more understandable way even when the pieces of posted information on a plurality of posting sites are collectively managed.

A first aspect of the invention provides an information display device. The information display device includes: a position acquisition unit configured to acquire a posting relevant location associated with posted information on a posting site; and an image display unit configured to display a posting relevant image that is an image associated with the posted information on the posting site and that includes an image indicating a type of the posting site. The image display unit is configured to display the posting relevant image at a location based on a remoteness and direction of the posting relevant location with respect to a current location within a predetermined display area about a location on a display screen, corresponding to the current location.

A second aspect of the invention provides a mobile terminal device. The mobile terminal device includes: a position acquisition unit configured to acquire a posting relevant location associated with posted information on a posting site; and an image display unit configured to display a posting relevant image on an in-vehicle display device connected to the mobile terminal device via communication, the posting relevant image being an image associated with the posted information on the posting site and including an image indicating a type of the posting site. The image display unit is configured to display the posting relevant image at a location based on a remoteness and direction of the posting relevant location with respect to a current location within a predetermined display area about a location on a display screen, corresponding to the current location.

According to the above first and second aspects, it is possible to provide an information display device and mobile terminal device that are able to provide the contents of pieces of posted information in a more understandable way even when the pieces of posted information on a plurality of posting sites are collectively managed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows an example of the configuration of an information display system according to an embodiment of the invention;

FIG. 2 is a front view of a mobile terminal device shown in FIG. 1;

FIG. 3 is a view that shows a state where the mobile terminal device is mounted on a dock;

FIG. 4 is a view that shows an example of a display image of an in-vehicle display according to the embodiment of the invention;

FIG. 5 is an enlarged view of a widget screen shown in FIG. 4;

FIG. 6 is a flowchart that shows the flow of a posting relevant image display process according to the embodiment of the invention; and

FIG. 7 is a flowchart that shows the flow of a posting relevant location guidance process according to the embodiment of the invention.

### DETAILED DESCRIPTION OF EMBODIMENTS

Hereinafter, an embodiment of the invention will be described with reference to the accompanying drawings.

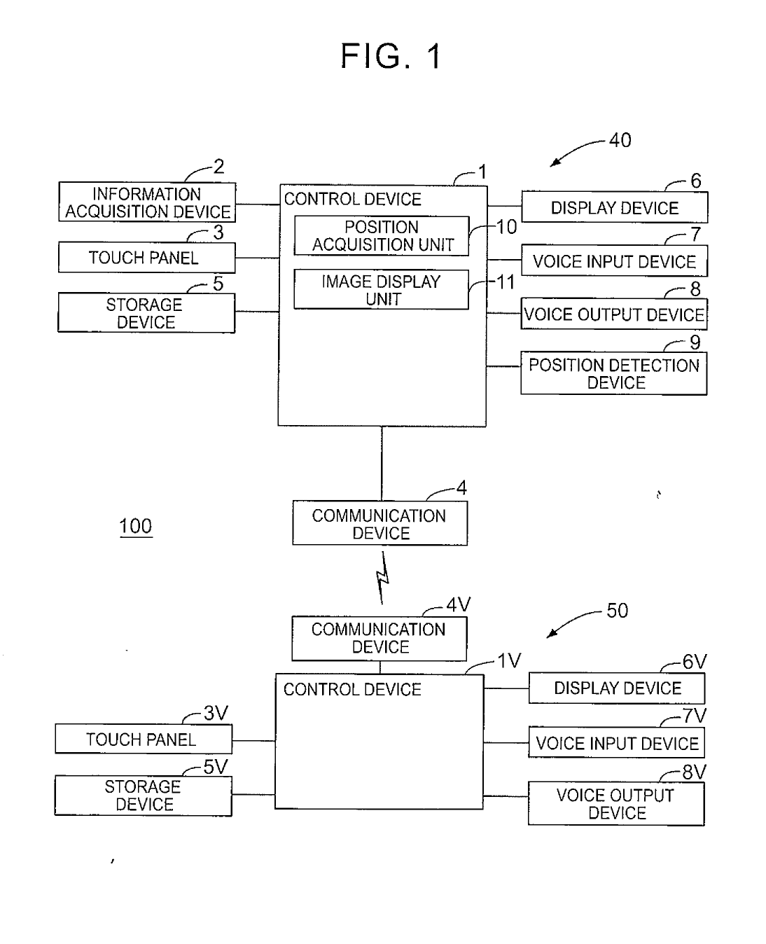

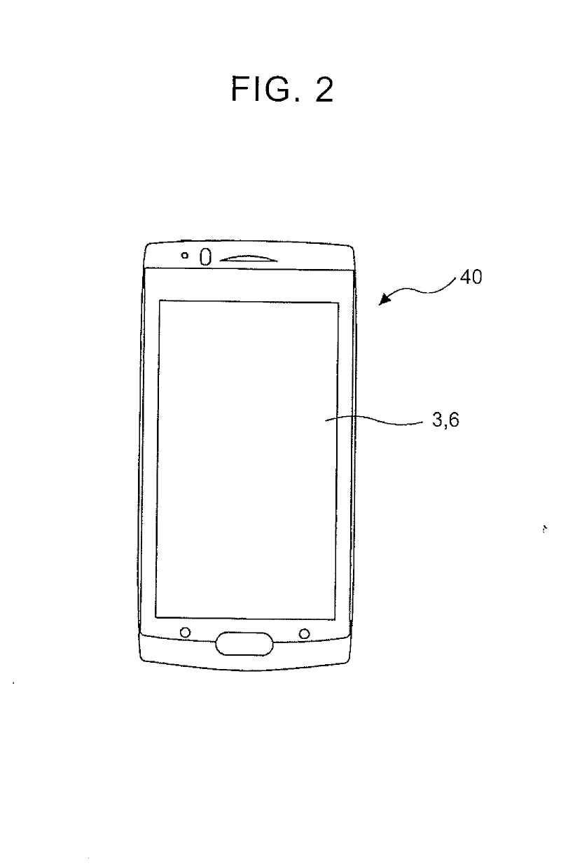

FIG. 1 is a block diagram that shows an example of the configuration of an information display system 100 according to the embodiment of the invention. The information display system 100 is a system that establishes cooperation between a mobile terminal device 40 and an in-vehicle device 50, and includes the mobile terminal device 40 and the in-vehicle device 50 as components. FIG. 2 is a front view of the mobile terminal device 40.

In the present embodiment, the information display system 100 displays a posting relevant image, received by the mobile terminal device 40, on a display device 6V connected to the in-vehicle device 50. The mobile terminal device 40 is connectable to posting sites.

The “posting sites” are sites that provide a posting function. Examples of the “posting sites” include an SNS site that provides a social networking service (hereinafter, referred to as “SNS”), such as Facebook (trademark) and Twitter (trademark), a word-of-mouth site, such as Tabelog (trademark), a travel site, such as Rakuten Travel (trademark), a blogging site, and the like. In addition, the posting sites each may be any one of a smartphone site that provides services for smartphones, a PC site that provides services for personal computers (PCs), a cellular phone site that provides services for cellular phones, a tablet PC site that provides services for tablet computers, and the like.

The “posted information” is information that is posted on a posting site by a user of the posting site, and includes a posting relevant location, posting site type information, a posting relevant image and contributor's information in the present embodiment.

The “posting relevant location” is a location associated with the posted information. In the present embodiment, examples of the “posting relevant location” include a posted location, a location associated with posted contents (for example, a location of a facility, or the like, on which a comment is made), a location at which a posted image is captured, and the like. The posting relevant location may be, for example, indicated by latitude and longitude.

The “posting site type information” is information that indicates the type of posting site. Examples of the “posting site type information” include an identification number, extension, and the like, that indicate the type of posting site.

The “contributor's information” is information associated with a contributor who posted the posted information. Examples of the “contributor's information” include an online name, and the like, of the contributor.

The “posting relevant image” is an image associated with the posted information. Examples of the “posting relevant image” include an image captured by a contributor (hereinafter, referred to as “posted image”), an image on which a comment is made (hereinafter, referred to as “commented image”), an image that indicates the type of posting site managing the posted information (hereinafter, referred to as “posting site type image”), an image associated with a contributor who posted the posted information (hereinafter, referred to as “contributor image”), and the like. Examples of the commented image include images of a hotel, a dish, and the like. Examples of the posting site type image include the logotype and trademark of the posting site. Examples of the contributor image include an avatar image. The posting site type image and the contributor image may be prestored in the mobile terminal device 40.

The mobile terminal device 40 is a terminal device that is carried by an occupant, and also functions as an information display device. In addition, examples of the mobile terminal device 40 include a cellular phone, a smartphone, a personal digital assistance (PDA), a potable game machine, a tablet computer, and the like. In the present embodiment, the mobile terminal device 40 is a smartphone, and mainly includes a control device 1, an information acquisition device 2, a touch panel 3, a communication device 4, a storage device 5, a display device 6, a voice input device 7, a voice output device 8 and a position detection device 9. The mobile terminal device 40 that serves as a smartphone, for example, uses a smartphone application as application software that runs on the mobile terminal device 40, and acquires posted information by accessing an SNS site in a server that provides an SNS.

The control device 1 is a device that controls the mobile terminal device 40, and is a computer that includes a central processing device (CPU), a random access memory (RAM), a read only memory (ROM), and the like, in the present embodiment. The control device 1, for example, loads programs corresponding to functional elements of a position acquisition unit 10 and image display unit 11 (described later) from the ROM and expands the programs in the RAM, and then causes the CPU to execute processes corresponding to the functional elements. The programs corresponding to the functional elements may be downloaded through a communication network or may be provided in a state where the programs are stored in a storage medium.

The information acquisition device 2 is a device that acquires information from an external device, and is a wireless communication device for utilizing a cellular phone line, a public wireless LAN, or the like, in the present embodiment.

The touch panel 3 is one of operation input devices mounted on the mobile terminal device 40, and is, for example, a multi-touch touch panel that is arranged on the display device 6 and that supports a multi-touch gesture function.

The communication device 4 is a device that controls communication with an external device. In the present embodiment, the communication device 4 is connected to a communication device 4V of the in-vehicle device 50 via near field communication (hereinafter, referred to as “NFC”). Wireless communication using Bluetooth (trademark), Wi-Fi (trademark), or the like, may be used for communication between the communication device 4 and the communication device 4V, and wire communication using a universal serial bus (USB) may be used for communication between the communication device 4 and the communication device 4V.

In the present embodiment, the communication device 4 periodically transmits a response request signal. When the communication device 4V receives the response request signal, the communication device 4V returns a response signal to the communication device 4. After that, when the communication device 4 receives the response signal, the communication device 4 establishes wireless communication with the communication device 4V. The communication device 4V may periodically transmit a response request signal, or each of the communication device 4 and the communication device 4V may periodically transmit a response request signal. In this case, when the communication device 4 receives the response request signal, the communication device 4 returns a response signal to the communication device 4V. After that, when the communication device 4V receives the response signal, the communication device 4V establishes wireless communication with the communication device 4. When the communication device 4 has established wireless communication with the communication device 4V, the communication device 4 outputs a control signal informing establishment of wireless communication to the control device 1.

The communication device 4, as in the case where the communication device 4 communicates with the in-vehicle device 50, may be configured to communicate with an external device other than the in-vehicle device 50. For example, the communication device 4 may be configured to wirelessly communicate with a communication device of another mobile terminal device while communicating with the communication device 4V.

The storage device 5 is a device that stores various pieces of information. Examples of the storage device 5 include a nonvolatile semiconductor memory, such as a flash memory. In the present embodiment, the storage device 5 stores past posted information.

The display device 6 is a device that displays various pieces of information, and is, for example, a liquid crystal display. The voice input device 7 is a device by which voice is input, and is, for example, a microphone. The voice output device 8 is a device that outputs various pieces of information by voice, and is, for example, a speaker.

The position detection device 9 is a device for detecting a current location of the mobile terminal device 40. In the present embodiment, the position detection device 9 is a global positioning system (GPS) receiver that receives GPS signals, output from GPS satellites, via a GPS antenna. The position detection device 9 detects the current location (latitude, longitude, altitude) of the mobile terminal device 40 on the basis of the received GPS signals, and outputs the detected result to the control device 1 as positional information.

The in-vehicle device 50 is a device mounted on a vehicle, and also functions as an information display device. The in-vehicle device 50 mainly includes a control device 1V, a touch panel 3V, the communication device 4V, a storage device 5V, the display device 6V, a voice input device 7V and a voice output device 8V. These component functions of the in-vehicle device 50 are respectively similar to the control device 1, touch panel 3, communication device 4, storage device 5, display device 6, voice input device 7 and voice output device 8 of the mobile terminal device 40, so the detailed description is omitted.

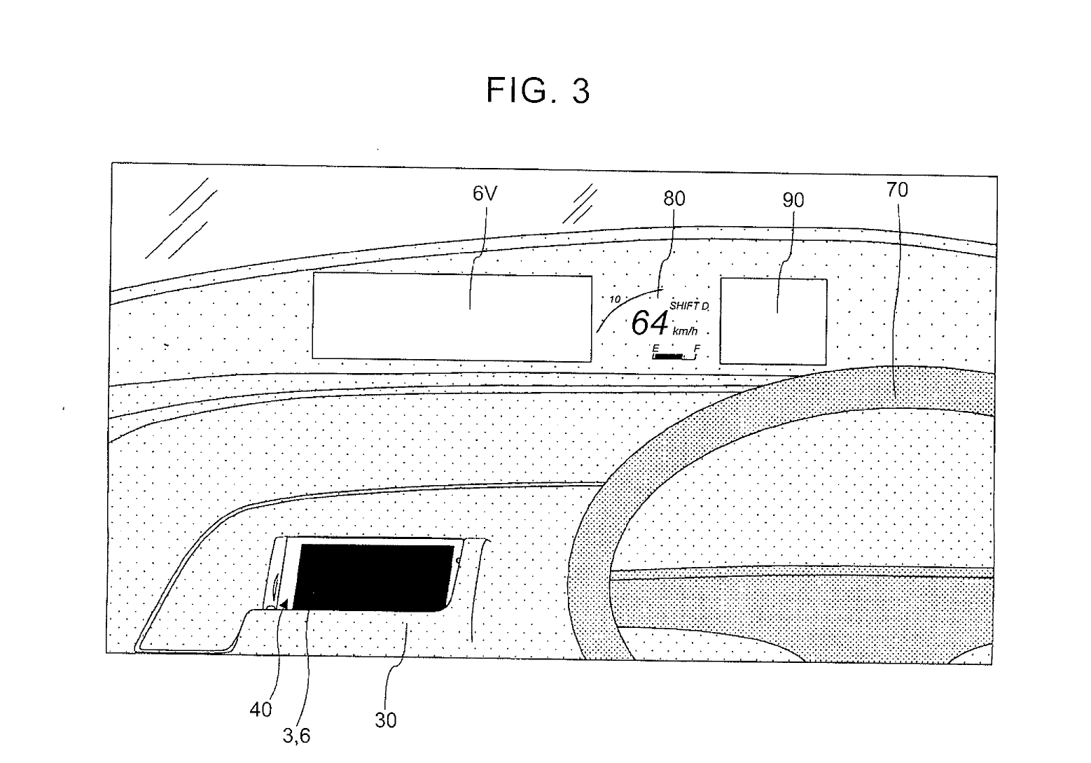

A situation in a vehicle cabin at the time when the information display system 100 functions will be described with reference to FIG. 3.

FIG. 3 shows a state where the mobile terminal device 40 is mounted on a cradle (dock) 30. As shown in FIG. 3, the mobile terminal device 40 is held by the dock 30 in a state where the touch panel 3 and the display device 6 are oriented toward a driver. At this time, the touch panel 3 of the mobile terminal device 40 may function as an operation input device of the in-vehicle device 50.

With this configuration, the driver is able to, for example, carry out input operation to the touch panel 3 by reaching a hand in a state where the driver is seated on a driver seat while the vehicle is stopped. In addition, the driver is able to visually recognize the display device 6V that displays navigation information, and the like, a speed meter 80 that indicates speed information and a multi-information display 90 that displays a communication status, battery state, and the like, of the mobile terminal device 40 as needed while driving.

When the mobile terminal device 40 is mounted in the dock 30 and wireless communication is established between the mobile terminal device 40 and the in-vehicle device 50, the information display system 100 extracts posted information that satisfies a predetermined condition from at least one of the posted information stored in the storage device 5 and posted information received in real time through the information acquisition device 2. The information display system 100 displays the posting relevant image associated with the extracted posted information on the display device 6V of the in-vehicle device 50.

Next, components that operate on the control device 1 of the mobile terminal device 40 will be described.

The position acquisition unit 10 acquires a posting relevant location. In the present embodiment, the position acquisition unit 10 acquires the posting relevant location included in at least one of the posted information stored in the storage device 5 and the posted information received via the information acquisition device 2.

Specifically, the position acquisition unit 10 acquires the positional information added to the posted image as the posting relevant location. In this case, positional information may be added to a posted image by a camera, or the like, used to capture the posted image at the time of capturing.

Alternatively, the position acquisition unit 10 acquires the positional information added to the posted information itself as the posting relevant location. In this case, positional information may be added to posted information, which is posted by a contributor, by a position detection device installed in a device, such as a cellular phone, used to post the posted information at the time of posting. When a contributor posts a comment on a theme to which positional information is added in advance (for example, a specific hotel, a specific restaurant, a specific amusement facility, or the like), positional information may be automatically added to the comment by a posting site that provides the theme.

The image display unit 11 displays a posting relevant image. In the present embodiment, the image display unit 11 displays posting relevant images associated with pieces of posted information on a plurality of posting sites registered by an operator in advance. Specifically, the image display unit 11 extracts pieces of posted information having posting relevant locations within a predetermined search area. The predetermined search area is an area that is searched for posted information, and is, for example, an area about the current location of the mobile terminal device 40, detected by the position detection device 9. The image display unit 11 may set a situation that an elapsed time from posted timing is shorter than or equal to a predetermined period of time as an additional extracting condition.

The image display unit 11 displays the posting relevant image associated with the extracted posted information on the display device 6V of the in-vehicle device 50 such that an operator is allowed to recognize the remoteness and direction of the posting relevant location with respect to the current location.

The “remoteness of the posting relevant location with respect to the current location” means the degree of easiness to which an operator reaches the posting relevant location. For example, as the distance between the current location and the posting relevant location increases or as a period of time required to reach the posting relevant location from the current location (hereinafter, referred to as “required arrival time”) extends, the posting relevant location is regarded as being more remote from the current location. The required arrival time may be a period of time that is determined in consideration of a road type, traffic congestion, or the like.

Thus, the predetermined search area is set on the basis of a distance when the remoteness of the posting relevant location with respect to the current location is determined on the basis of a distance. Specifically, the predetermined search area is set as an area within a predetermined distance range from the current location.

The predetermined search area is set on the basis of a required arrival time when the remoteness of the posting relevant location with respect to the current location is determined on the basis of a required arrival time. Specifically, the predetermined search area is set as an area that includes points reachable from the current location within a predetermined period of time.

The image display unit 11 may change the size of the predetermined search area on the basis of a travel speed (for example, an average travel speed in a predetermined period) of the vehicle. Specifically, the image display unit 11 may be configured to increase the predetermined search area as the travel speed of the vehicle increases.

The image display unit 11 displays a predetermined display area corresponding to the predetermined search area (hereinafter, referred to as “search area image”) on the display device 6V of the in-vehicle device 50. After that, the image display unit 11 superimposes the posting relevant image on the search area image at a location based on the remoteness and direction of the posting relevant location with respect to the current location. In the present embodiment, the search area image may be a circular image like a plan position indicator (PPI) scope of a radar, and an icon that indicates the current location may be arranged at the center of the search area image. The size of the search area image that is displayed on the display device 6V is constant irrespective of the size of the predetermined search area. However, the size of the search area image may be changed on the basis of the size of the predetermined search area.

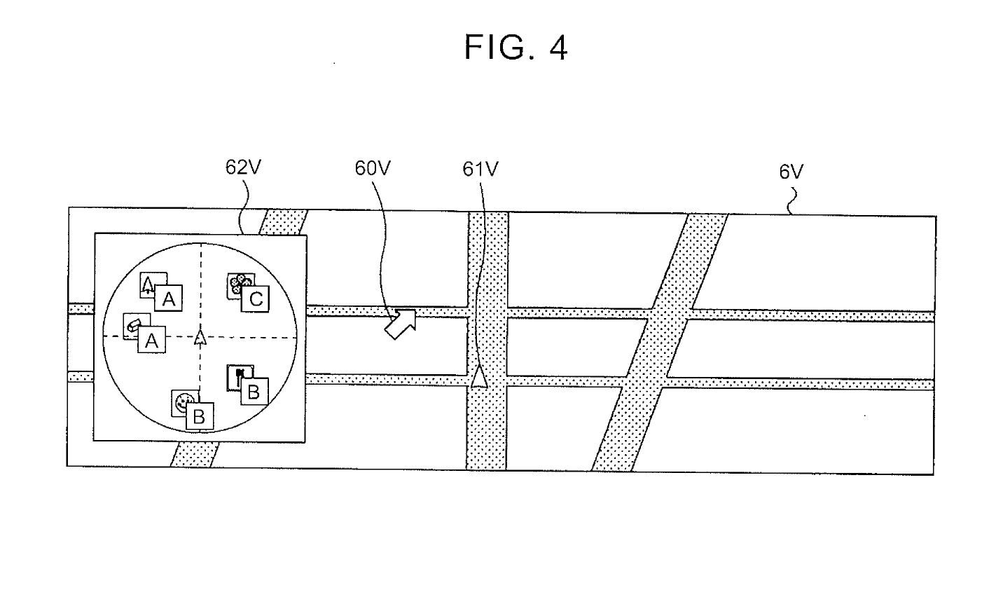

FIG. 4 shows an example of a display screen in the display device 6V. As shown in FIG. 4, the display screen of the display device 6V includes a cursor 60V, a host vehicle location icon 61V and a widget screen 62V that are superimposed on a map image. The widget screen 62V is a screen that a widget displays on the display device 6V.

The “widget” is small application software (hereinafter, referred to as “APP”) that operates on the mobile terminal device 40. In the present embodiment, the widget includes an APP that is run by the image display unit 11. An image that is displayed on the widget screen 62V includes a search area image that is displayed by the image display unit 11 and posting relevant images that are superimposed on the search area image.

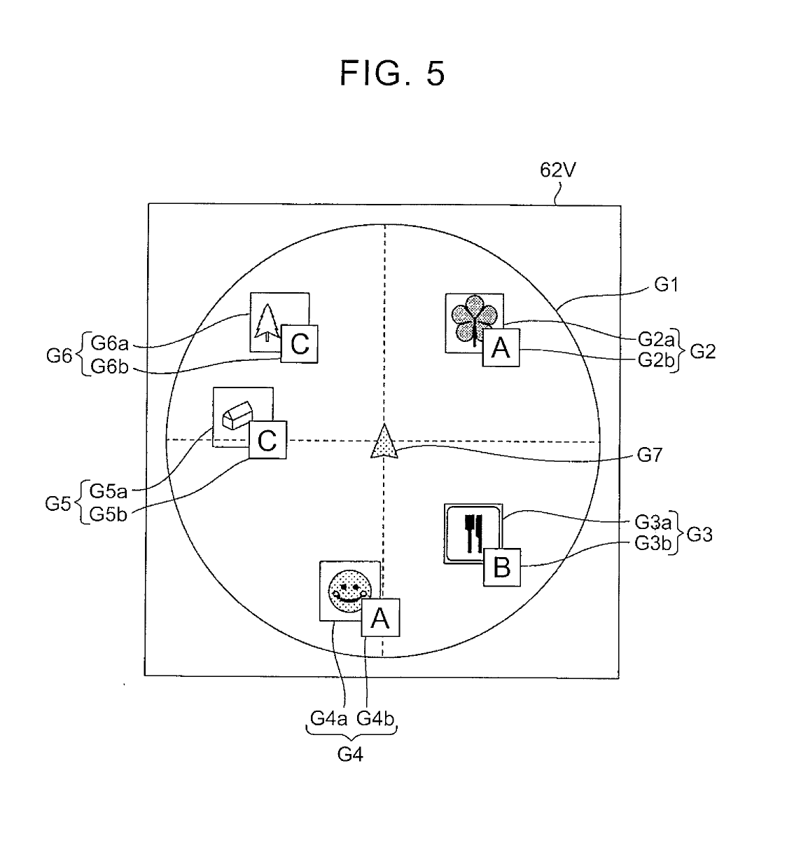

FIG. 5 is an enlarged view of the widget screen 62V shown in FIG. 4. As shown in FIG. 5, the image display unit 11 displays a circular search area image G1 such that the north direction coincides with the upward direction of the display device 6V on the basis of an output of a direction sensor (not shown), such as a compass, in the mobile terminal device 40 or the in-vehicle device 50. The image display unit 11 may display a search area image such that a vehicle travel direction coincides with the upward direction of the display device 6V on the basis of an output of a direction sensor.

The image display unit 11 displays posting relevant images G2 to G6 at locations based on the remotenesses and directions of the posting relevant locations with respect to the current location on the search area image G1. The posting relevant image G2 includes a posted image G2a and a posting site type image G2b. The posting relevant image G3 includes a commented image G3a and a posting site type image G3b. The posting relevant image G4 includes a contributor image G4a and a posting site type image G4b. The posting relevant image G5 includes a commented image G5a and a posting site type image G5b. The posting relevant image G6 includes a posted image G6a and a posting site type image G6b. An icon G7 indicates the current location of the mobile terminal device 40.

The operator is allowed to recognize two pieces of posted information associated with the posting site “A”, one piece of posted information associated with the posting site “B” and two pieces of posted information associated with the posting site “C” by taking a look at the search area image G1 shown in FIG. 5. The operator is allowed to easily recognize in which directions the posting relevant locations associated with the respective pieces of posted information are located with respect to the current location and how far the posting relevant locations are.

The operator is allowed to easily recognize which posting site each piece of posted information belongs to by taking a look at the posting site type images G2b to G6b, and is allowed to estimate the property (for example, authenticity) of each piece of the posted information on the basis of the property (for example, anonymity) of the corresponding posting site.

The operator is allowed to estimate the contents of the corresponding pieces of posted information by taking a look at the posted images G2a, G6a and the commented images G3a, G5a. The operator is allowed to easily recognize who is the contributor and to estimate the contents of the corresponding piece of the posted information by taking a look at the contributor image G4a.

The image display unit 11 displays the posting relevant images G2 to G6 in set display size irrespective of the remoteness of each posting relevant location from the current location. Instead, the display size of each posting relevant image may be reduced as the posting relevant location gets remote from the current location.

As shown in FIG. 4, the image display unit 11 displays the widget screen 62V including the search area image G1 in addition to a map image that is displayed by a route guidance APP that is run by the mobile terminal device 40 or the in-vehicle device 50. Specifically, the image display unit 11 pops up the widget screen 62V as another window in addition to the map image. The image display unit 11 causes the host vehicle location icon 61V indicating the current location on the map image not to be hidden by the widget screen 62V. Thus, the image display unit 11 is able to separately control the scale of the map image and the scale of the search area image G1. The image display unit 11 may integrate the search area image G1 with the map image. Specifically, the image display unit 11 may display each posting relevant image on the map image at a location corresponding to the posting relevant location. The image display unit 11 may respectively display the map image and the search area image on separate in-vehicle displays. The image display unit 11 may display the search area image without displaying the map image.

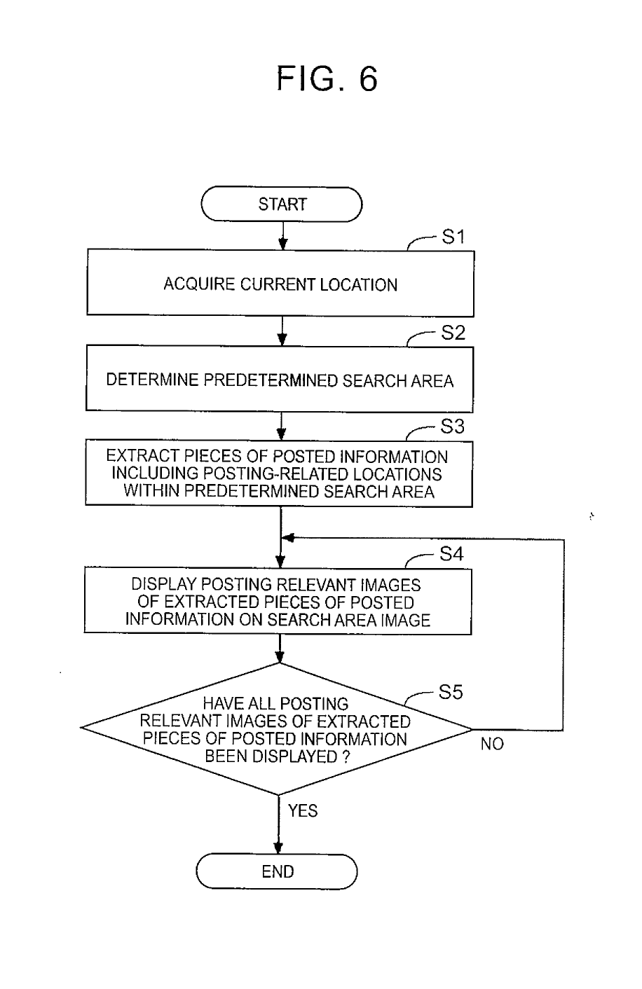

Next, a process in which the mobile terminal device 40 displays a posting relevant image at a corresponding posting relevant location (hereinafter, referred to as “posting relevant image display process”) will be described with reference to FIG. 6. FIG. 6 is a flowchart that shows the flow of the posting relevant image display process. The mobile terminal device 40 repeatedly executes the posting relevant image display process at predetermined intervals.

Initially, the control device 1 of the mobile terminal device 40 acquires the current location on the basis of the output of the position detection device 9 (step S1).

After that, the control device 1 determines an area within a predetermined distance range from the current location as the predetermined search area (step S2). The control device 1 may determine an area including points that are reachable from the current location within a predetermined period of time as the predetermined search area.

After that, the image display unit 11 in the control device 1 extracts pieces of posted information having posting relevant locations within the predetermined search area (step S3). The posting relevant location of each piece of posted information is acquired by the position acquisition unit 10 of the control device 1.

After that, the image display unit 11 displays the posting relevant images of the extracted pieces of posted information on the search area image (step S4). Specifically, the image display unit 11 displays the posting relevant images on the search area image at locations based on the remotenesses and directions of the posting relevant locations with respect to the current location on the basis of the current location and the posting relevant locations.

After that, the control device 1 determines whether all the posting relevant images associated with the extracted pieces of posted information have been displayed (step S5).

When it is determined that not all the posting relevant images associated with the extracted pieces of posted information have been displayed yet (NO in step S5), the control device 1 repeats the processes from step S4.

On the other hand, when it is determined that all the posting relevant images associated with the extracted pieces of posted information have been displayed (YES in step S5), the control device 1 ends the current posting relevant image display process.

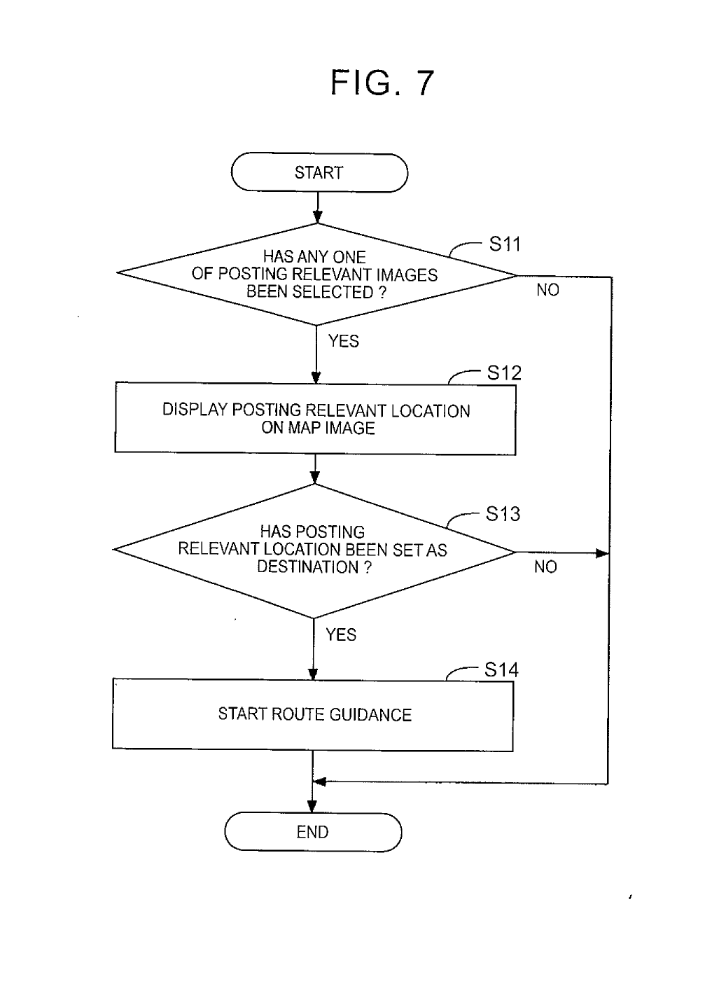

Next, a process in which the mobile terminal device 40 starts route guidance on the basis of a posting relevant location (hereinafter, referred to as “posting relevant location guidance process”) will be described with reference to FIG. 7. FIG. 7 is a flowchart that shows the flow of the posting relevant location guidance process. The mobile terminal device 40 repeatedly executes the posting relevant location guidance process at predetermined intervals.

Initially, the control device 1 of the mobile terminal device 40 determines whether one of the posting relevant images on the search area image has been selected (step S11). For example, when the cursor 60V (see FIG. 4) is put on one of the posting relevant images on the search area image through operator's drag operation to the touch panel 3, the control device 1 determines that the posting relevant image has been selected.

When it is determined that no posting relevant image on the search area image has been selected (NO in step S11), the control device 1 ends the current posting relevant location guidance process.

On the other hand, when it is determined that one of the posting relevant images on the search area image has been selected (YES in step S11), the control device 1 displays the posting relevant location of the posted information having the posting relevant image on the map image (step S12). For example, the control device 1 blinks a point on the map image corresponding to the posting relevant location of the posted information having the posting relevant image. At this time, the control device 1 may scale up or down the map image in order to display the point on the map image, corresponding to the posting relevant location in appropriate size. Specifically, the control device 1 provides the posting relevant location to the route guidance APP that operates on the control device 1V of the in-vehicle device 50, and blinks the corresponding point on the map image.

After that, the control device 1 determines whether the posting relevant location has been set as a destination (step S13). For example, when selection of one of the posting relevant images on the search area image, pointed by the cursor 60V (see FIG. 4), has been fixed through operator's double-tap operation to the touch panel 3, the control device 1 determines that the posting relevant location of the posted information having the posting relevant image has been set as a destination.

When it is determined that the posting relevant location has not been set as a destination (NO in step S13), the control device 1 ends the current posting relevant location guidance process.

On the other hand, when it is determined that the posting relevant location has been set as a destination (YES in step S13), the control device 1 starts a route guidance leading to the posting relevant location (step S14). Specifically, the control device 1 provides the posting relevant location as a destination to the route guidance APP that operates on the control device 1V of the in-vehicle device 50, causes the route guidance APP to search for a route leading to the posting relevant location, and causes the route guidance APP to start route guidance along the route.

As described above, the mobile terminal device 40 displays the posting relevant image including the posting site type image on the search area image such that the operator is allowed to recognize the remoteness and direction of the posting relevant location with respect to the current location. Therefore, even when the mobile terminal device 40 collectively manages pieces of posted information on a plurality of posting sites, the mobile terminal device 40 is able to provide the contents of the pieces of posted information to the operator in a more understandable way.

The mobile terminal device 40 displays the posting relevant images including a posted image, a commented image, a contributor image, and the like, on the search area image. Therefore, the mobile terminal device 40 is able to provide the contents of pieces of posted information to the operator in a more understandable way in comparison with the case where characters, icons, and the like, are displayed.

The mobile terminal device 40 separately displays the map image and the search area image. Therefore, the mobile terminal device 40 is able to provide the contents of pieces of posted information to the operator in a more understandable way without displaying the map image in an excessively complex manner.

The mobile terminal device 40 sets a predetermined search area as an area within a predetermined distance range from the current location or an area including reachable points within a predetermined period of time from the current location. The mobile terminal device 40 extracts pieces of posted information including posting relevant locations relatively close from the current location, and displays posting relevant images associated with the pieces of posted information. Therefore, the mobile terminal device 40 is able to prevent an excessive increase in the number of the posting relevant images displayed, and to provide the contents of the pieces of posted information to the operator in a more understandable way.

The mobile terminal device 40 changes the size of the predetermined search area on the basis of the travel speed of the vehicle. The mobile terminal device 40 extracts pieces of posted information including posting relevant locations relatively close from the current location with consideration of the travel speed, and displays posting relevant images associated with the pieces of posted information. Therefore, the mobile terminal device 40 is able to provide the contents of pieces of posted information to the operator in a more understandable way by setting proper timing to display the posting relevant images.

The embodiment of the invention is described in detail; however, the invention is not limited to the above-described embodiment. Various modifications and replacements may be added to the above-described embodiment without departing from the scope of the invention.

For example, in the above-described embodiment, the position acquisition unit 10 and the image display unit 11 are executed on the control device 1 of the mobile terminal device 40; instead, part or all of them may be executed on the control device 1V of the in-vehicle device 50.

In the above-described embodiment, the current location is based on the output of the position detection device 9 of the mobile terminal device 40; instead, the current location may be based on an output of an in-vehicle position detection device connected to the in-vehicle device 50.

In the above-described embodiment, the posted information includes posted information that is acquired via the information acquisition device 2 of the mobile terminal device 40; instead, the posted information may include posted information that is acquired via an in-vehicle information acquisition device connected to the in-vehicle device 50.

In the above-described embodiment, when the mobile terminal device 40 is mounted on the dock 30, wireless communication is established between the mobile terminal device 40 and the in-vehicle device 50. Instead, wireless communication may be established between the mobile terminal device 40 and the in-vehicle device 50 when the mobile terminal device 40 is present in a predetermined area around the driver seat.

What is claimed is:

1. An information display device comprising:
a position acquisition unit configured to acquire a posting relevant location associated with posted information on a posting site; and
an image display unit configured to display a posting relevant image that is an image associated with the posted information on the posting site and that includes an image indicating a type of the posting site, wherein
the image display unit is configured to display the posting relevant image at a location based on a remoteness and direction of the posting relevant location with respect to a current location within a predetermined display area about a location on a display screen, corresponding to the current location.

2. The information display device according to claim 1, wherein the image display unit is configured to display the predetermined display area separately from a map image.

3. The information display device according to claim 2, wherein the image display unit is configured to display the predetermined display area such that the predetermined display area does not hide an indication indicating the current location on the map image.

4. The information display device according to claim 1, wherein the image display unit is configured to display the predetermined display area without displaying the map image.

5. The information display device according to claim 1, wherein the predetermined display area corresponds to a predetermined search area, and the predetermined search area is set as an area within a predetermined distance range from the current location or an area including a point reachable from the current location within a predetermined period of time.

6. The information display device according to claim 5, wherein the size of the predetermined search area is changed on the basis of a travel speed of a vehicle.

7. A mobile terminal device comprising:
a position acquisition unit configured to acquire a posting relevant location associated with posted information on a posting site; and
an image display unit configured to display a posting relevant image on an in-vehicle display device connected to the mobile terminal device via communication, the posting relevant image being an image associated with the posted information on the posting site and including an image indicating a type of the posting site, wherein
the image display unit is configured to display the posting relevant image at a location based on a remoteness and direction of the posting relevant location with respect to a current location within a predetermined display area about a location on a display screen, corresponding to the current location.
